(19) United States
(12) Patent Application Publication
(10) Pub. No.: US 2025/0203356 A1
(43) Pub. Date: Jun. 19, 2025

(54) MAINTAINING AUTHENTICATION INTEGRITY OF SIGNALS FROM BACKSCATTERING-BASED COMMUNICATIONS DEVICES

(71) Applicant: QUALCOMM Incorporated, San Diego, CA (US)

(72) Inventors: Ahmed ELSHAFIE, San Diego, CA (US); Yuchul KIM, San Diego, CA (US); Alexandros MANOLAKOS, Athens (GR); Hung Dinh LY, San Diego, CA (US); Zhikun WU, Beijing (CN); Linhai HE, San Diego, CA (US); Huilin XU, Temecula, CA (US); Wanshi CHEN, San Diego, CA (US); Peter GAAL, San Diego, CA (US); Seyedkianoush HOSSEINI, San Diego, CA (US)

(21) Appl. No.: 18/876,614

(22) PCT Filed: Aug. 1, 2022
(86) PCT No.: PCT/CN2022/109371

§ 371 Date: Dec. 18, 2024

(51) Int. Cl. H04W 12/0431; H04W 8/22; H04W 12/06

(52) U.S. Cl. CPC H04W 12/0431; H04W 8/22; H04W 12/06

(57) ABSTRACT

A first wireless device may be configured to transmit a first public key, an unsigned transmission, and a signed transmission to a backscattering-based communications device. The signed transmission may be signed based on a first private key. The backscattering-based communications device may be configured to receive the first public key, the unsigned transmission, and the signed transmission from the first wireless device. The backscattering-based communications device may be configured to process the unsigned transmission in response to verifying the signed transmission based on the first public key. The backscattering-based communications device may be configured to transmit a verification of the signed transmission in response to verifying the signed transmission based on the first public key.

### TECHNICAL FIELD

The present disclosure relates generally to communication systems, and more particularly, to a wireless network system using backscattering-based communications devices.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A backscattering-based communication device may be used to extend a range of a wireless device, or provide battery-less or limited energy storage and functionality for wireless devices. However, backscattering-based communications devices may have limited security when receiving and reflecting a signal, or when receiving and processing a command or a query of a signal. For example, a backscattering-based communications device may have a simple password that accompanies a command or a query that may be used by the backscattering-based communications device to authenticate a device transmitting the command or query. Such simple security measures may be easily spoofed by a fake tag or a fake wireless device. A backscattering-based communication device with a higher level of security may be more difficult to spoof. Such a device may use public keys and private keys to authenticate one or more transmissions from a wireless device to the backscattering-based communication device, or from the backscattering-based communication device to a wireless device, using validated, signed transmissions. If the backscattering-based communication device or a wireless device determines that a signed transmission fails authentication, one or more detected errors may be transmitted to re-secure communications between wireless devices and the backscattering-based communication device.

In an aspect of the disclosure, a method, a computer-readable medium, and an apparatus are provided. The apparatus may have a memory and at least one processor coupled to the memory at a first wireless device. Based at least in part on information stored in the memory, the at least one processor may be configured to transmit a first public key to a backscattering-based communications device. Based at least in part on information stored in the memory, the at least one processor may be configured to transmit an unsigned transmission to the backscattering-based communications device. Based at least in part on information stored in the memory, the at least one processor may be configured to transmit a signed transmission to the backscattering-based communications device. The signed transmission may be signed based on a first private key.

In an aspect of the disclosure, a method, a computer-readable medium, and an apparatus are provided. The apparatus may have a memory and at least one processor coupled to the memory at a second wireless device. Based at least in part on information stored in the memory, the at least one processor may be configured to receive a configuration of a backscattering-based communications device from a first wireless device. Based at least in part on information stored in the memory, the at least one processor may be configured to receive a backscattered signal from the backscattering-based communications device. Based at least in part on information stored in the memory, the at least one processor may be configured to transmit a first detected error to the first wireless device in response to detecting an error in the backscattered signal based on the configuration of the backscattering-based communications device.

In an aspect of the disclosure, a method, a computer-readable medium, and an apparatus are provided. The apparatus may have a memory and at least one processor coupled to the memory at a backscattering-based communications device. Based at least in part on information stored in the memory, the at least one processor may be configured to receive a first public key from a first wireless device. Based at least in part on information stored in the memory, the at least one processor may be configured to receive an unsigned transmission from the first wireless device. Based at least in part on information stored in the memory, the at least one processor may be configured to receive a signed transmission from the first wireless device. Based at least in part on information stored in the memory, the at least one processor may be configured to process the unsigned transmission in response to verifying the signed transmission based on the first public key.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRA WINGS

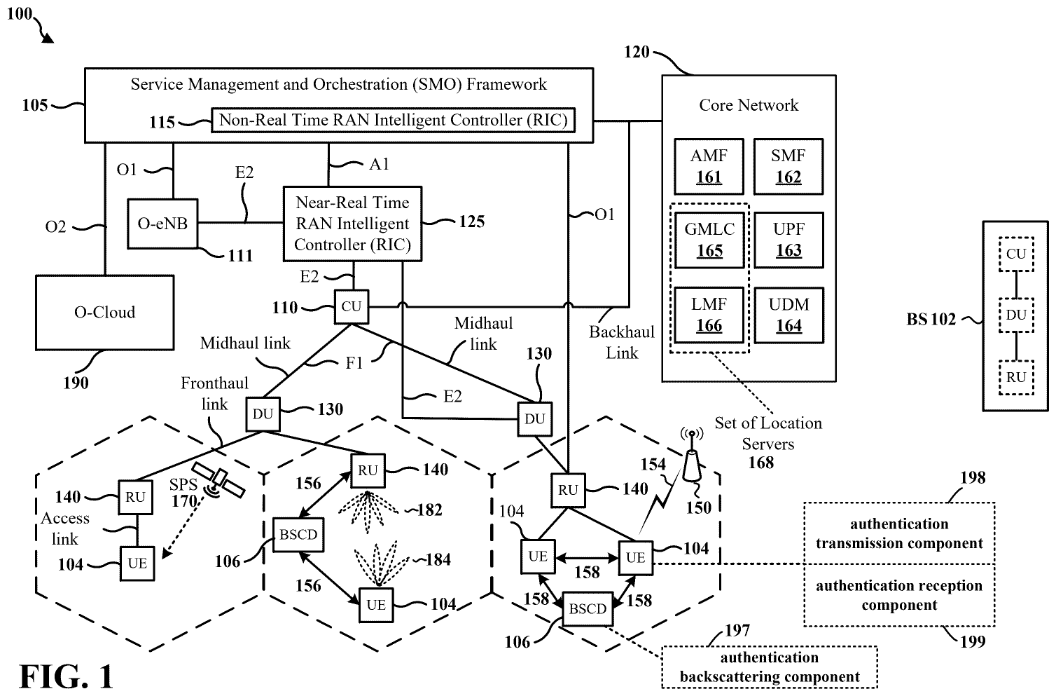

FIG. 1 is a diagram illustrating an example of a wireless communications system and an access network.

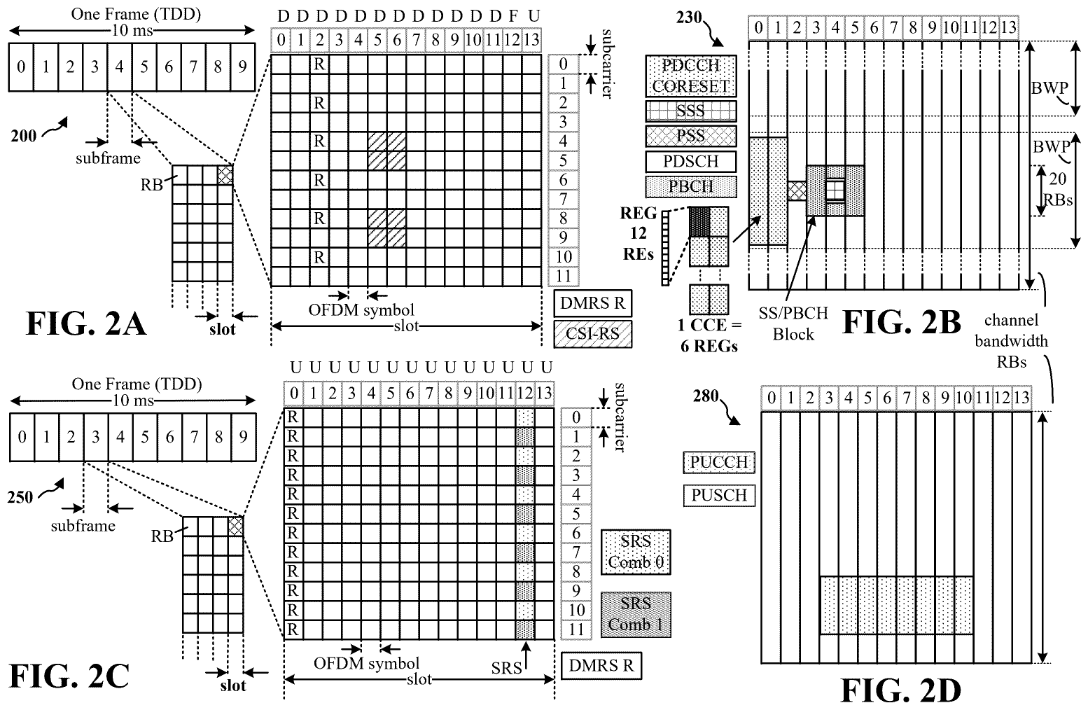

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

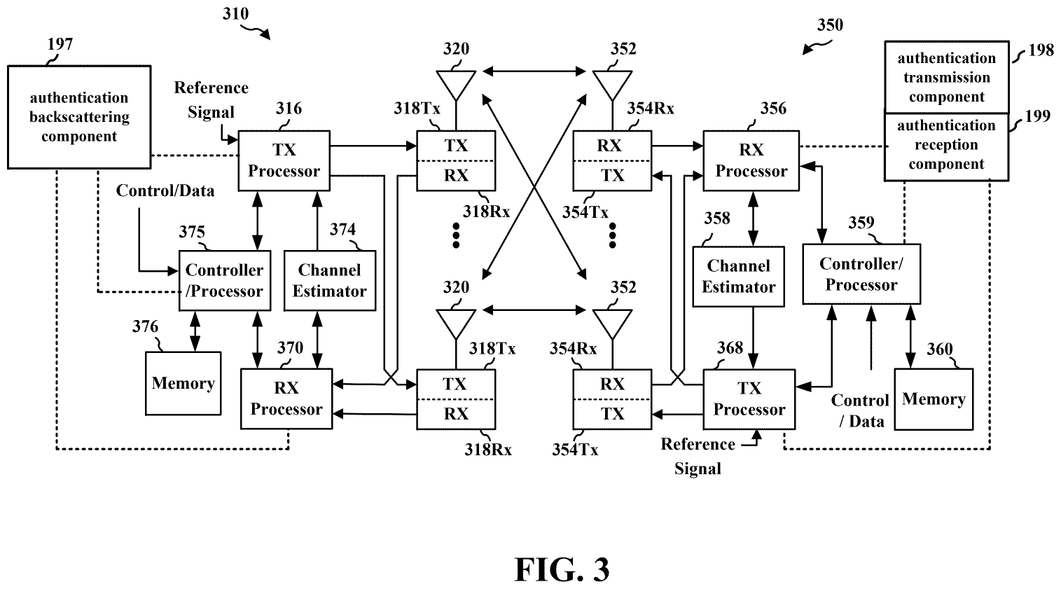

FIG. 3 is a diagram illustrating an example of a base station and user equipment (UE) in an access network.

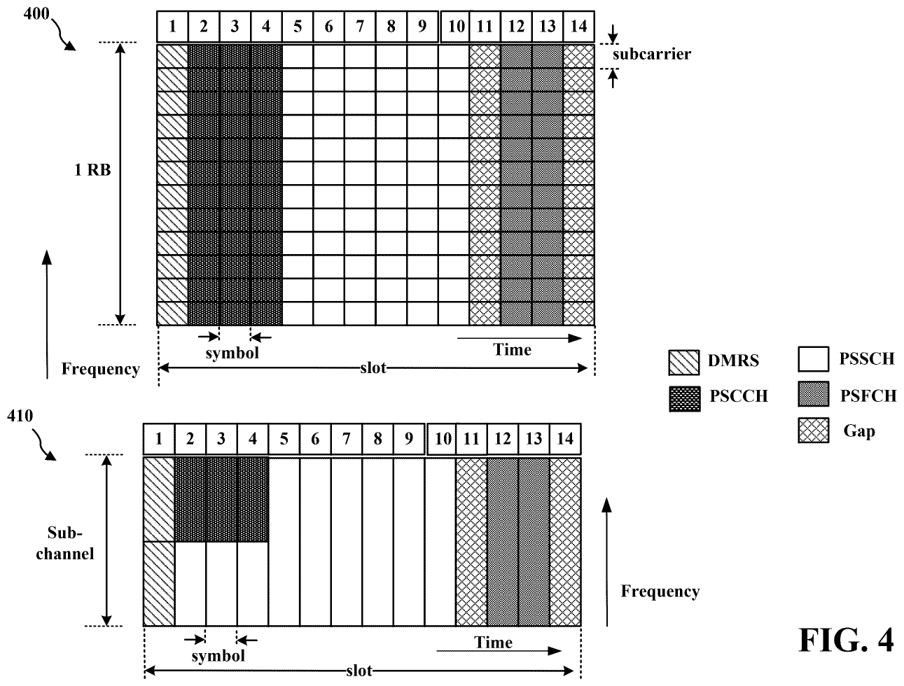

FIG. 4 illustrates example aspects of a sidelink slot structure, in accordance with various aspects of the present disclosure.

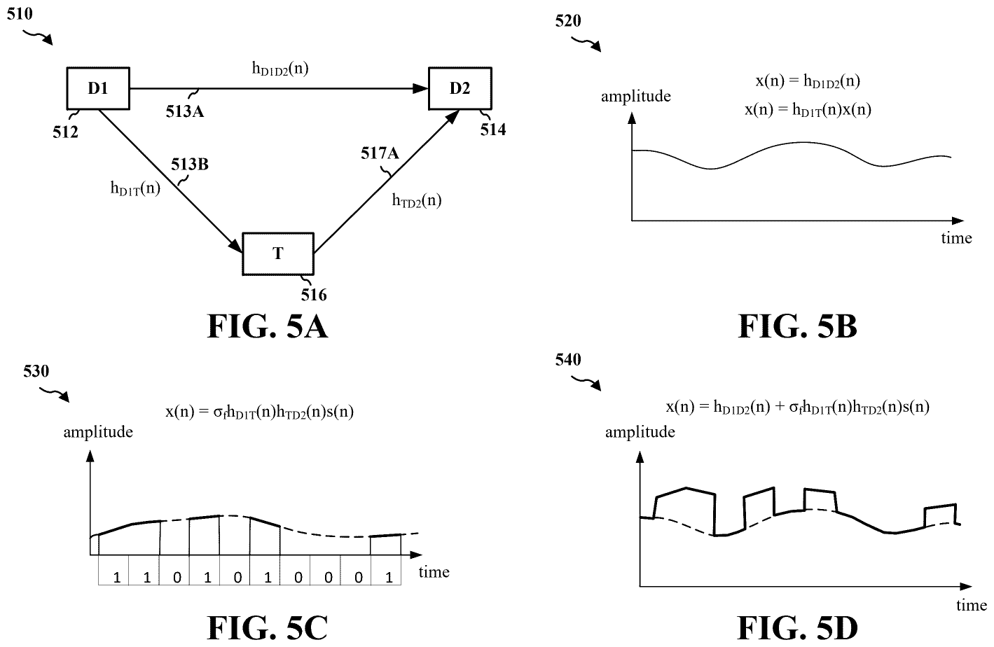

FIG. 5A is a diagram illustrating an example of a wireless communications system having a backscattering-based communications device that may reflect or backscatter a signal a first UE to a second UE.

FIG. 5B is a diagram illustrating an example of a radio wave transmitted by a wireless communications device.

FIG. 5C is a diagram illustrating an example of a backscattered signal that modulates the radio wave of FIG. 5B.

FIG. 5D is a diagram illustrating an example of a superposition of the radio wave of FIG. 5B and the radio wave of FIG. 5C.

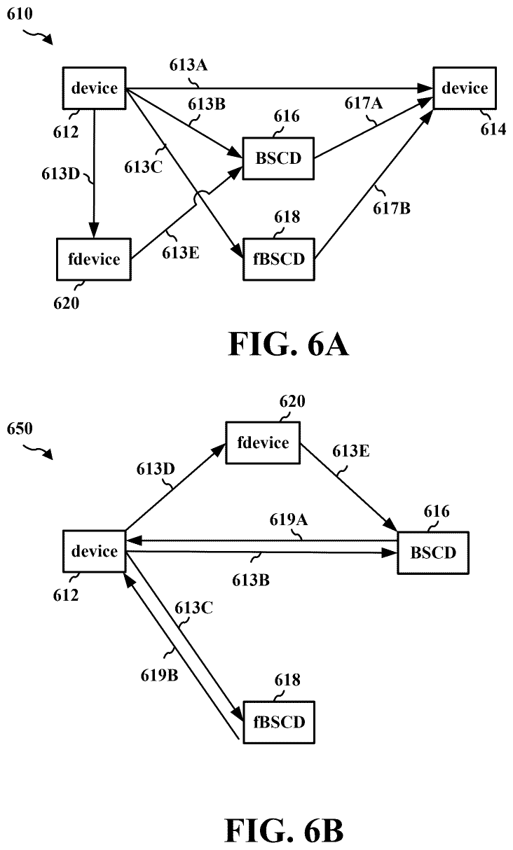

FIG. 6A is a diagram illustrating an example of a bistatic wireless communications system with a receiving UE configured to authenticate a backscattering-based communications device.

FIG. 6B is a diagram illustrating an example of a monostatic wireless communications system with a UE configured to authenticate a backscattering-based communications device.

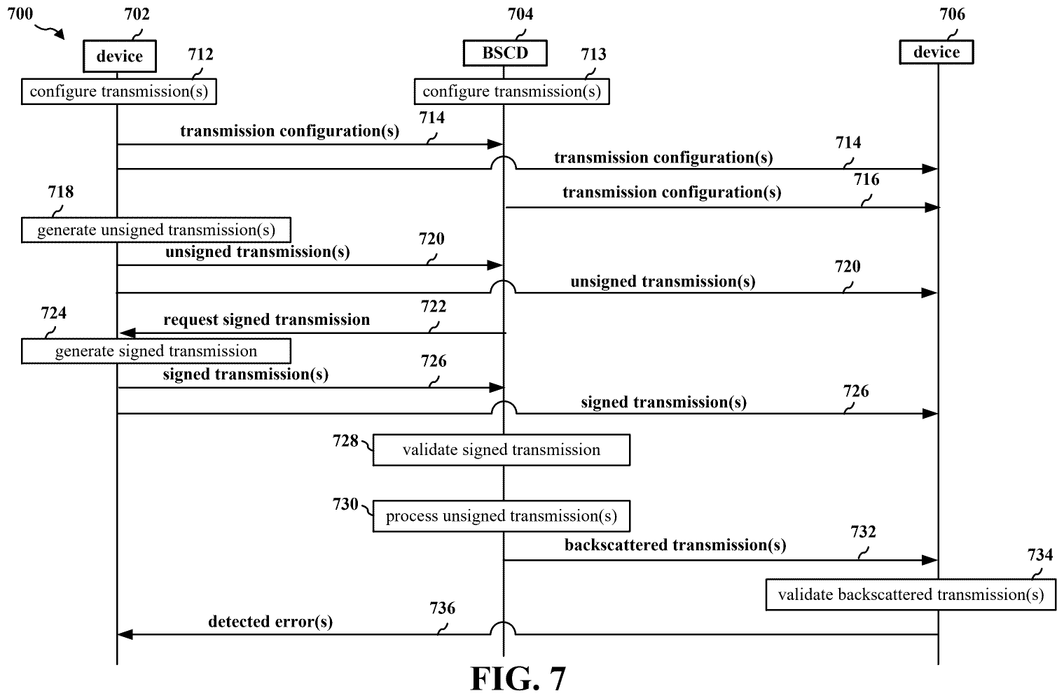

FIG. 7 shows a connection flow diagram of a bistatic wireless communications system with a receiving UE configured to authenticate a backscattering-based communications device.

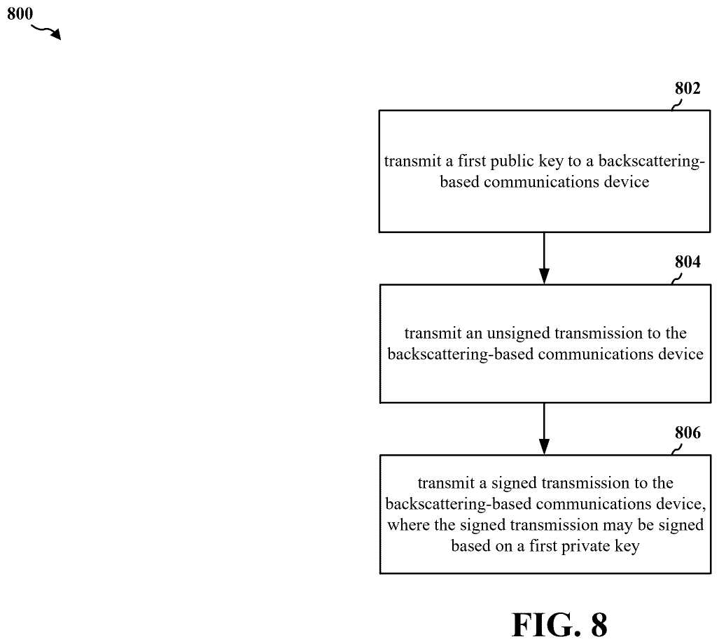

FIG. 8 is a flowchart of a method of wireless communication.

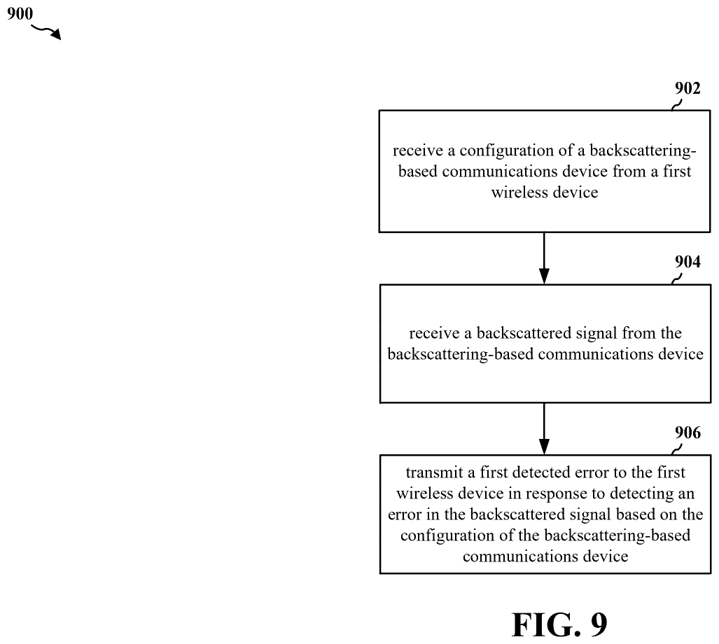

FIG. 9 is another flowchart of a method of wireless communication.

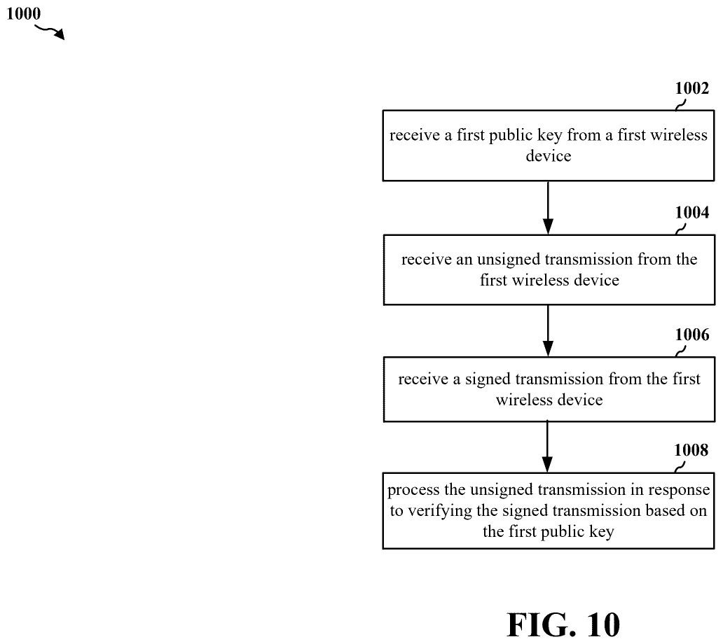

FIG. 10 is another flowchart of a method of wireless communication.

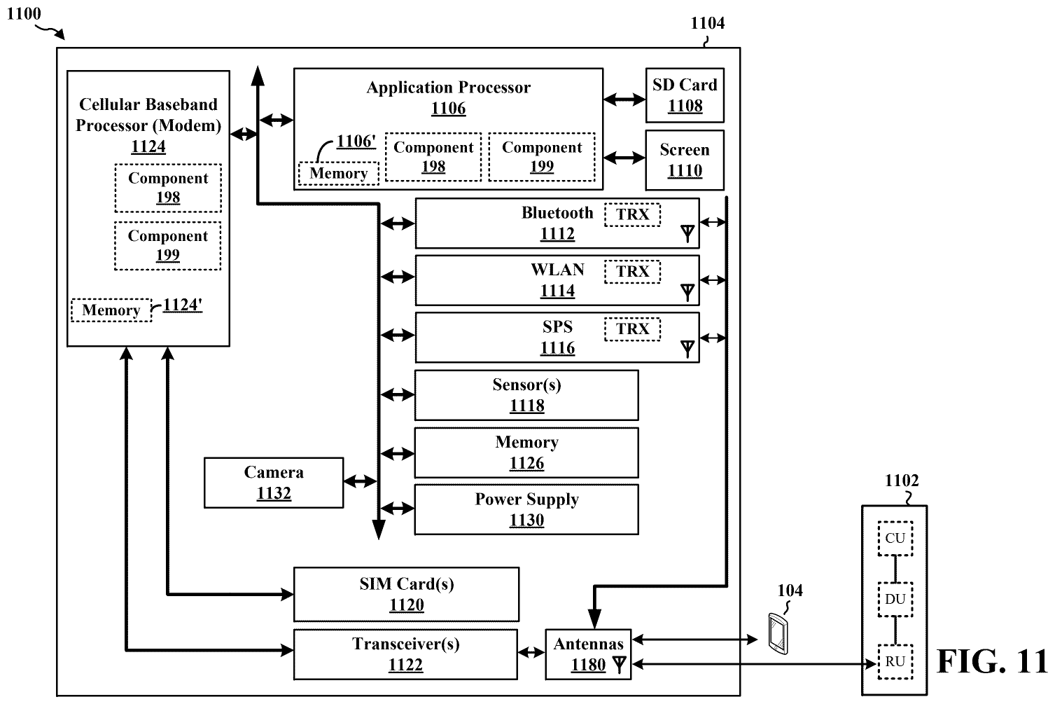

FIG. 11 is a diagram illustrating an example of a hardware implementation for an example apparatus and/or network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RTRIC 125. The Near-RTRIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RTRIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR. The UEs 104 may be connected to one another using a PC5 interface to maintain the D2D communication link 158.

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. A V2X communication may include a basic safety message (BSM) Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 4. Although the following description, including the example slot structure of FIG. 4, may provide examples for sidelink communication in connection with 5G NR, the concepts described herein may be applicable to other similar areas, such as LTE, LTE-A, CDMA, GSM, and other wireless technologies.

One or more wireless signals may be relayed to another device via a backscattering-based communications device 106 via a D2D communication link 158. In one aspect, a UE 104 may communicate with another UE 104 via a backscattering-based communications device 106 that may be configured to backscatter a signal received via a D2D communication link 158. In another aspect, an RU 140 may communicate with a UE 104 via a backscattering-based communications device 106 that may be configured to backscatter a signal received via a UE to a universal mobile telecommunications system (UMTS) terrestrial radio access (UTRA) (Uu) link 156. The backscattered signal using the D2D communication link or the Uu link 156 may include a superposition of both a direct link signal and a backscatter signal from the source device.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHZ-52.6 GHz). Although a portion of FR1 is greater than 6 GHz, FR1 is often referred to (interchangeably) as a “sub-6 GHZ” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHZ” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell identifier (ID) (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an authentication transmission component 198 configured to transmit a first public key to a backscattering-based communications device. The authentication transmission component 198 may be configured to transmit an unsigned transmission to the backscattering-based communications device. The authentication transmission component 198 may be configured to transmit a signed transmission to the backscattering-based communications device. The signed transmission may be signed based on a first private key. In certain aspects, the UE 104 may have an authentication reception component 199 configured to receive a configuration of a backscattering-based communications device from a first wireless device. The authentication reception component 199 may be configured to receive a backscattered signal from the backscattering-based communications device. The authentication reception component 199 may be configured to transmit a first detected error to the first wireless device in response to detecting an error in the backscattered signal based on the configuration of the backscattering-based communications device. In certain aspects, the backscattering-based communications device 106 may have an authentication backscattering component 197 configured to receive a first public key from a first wireless device. The authentication backscattering component 197 may be configured to receive an unsigned transmission from the first wireless device. The authentication backscattering component 197 may be configured to receive a signed transmission from the first wireless device. The authentication backscattering component 197 may be configured to process the unsigned transmission in response to verifying the signed transmission based on the first public key. Although the following description may be focused on radio-frequency identification (RFID) tags, the concepts described herein may be applicable to any backscattering-based communication devices, such as a UE equipped with an RFID tag radio or a UE that uses backscattering-based communications to save power during a mode (e.g., power-saving mode, reflection mode).

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic pre fix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

FIG. 3 is a block diagram of a backscattering-based communications device 310 in communication with a wireless device 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the wireless device 350. Each spatial stream may then be provided to a different antenna 320 via a separate transmitter 318Tx. Each transmitter 318Tx may modulate a radio frequency (RF) carrier with a respective spatial stream for transmission.

At the wireless device 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the wireless device 350. If multiple spatial streams are destined for the wireless device 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the backscattering-based communications device 310. These soft decisions may be based on channel estimates computed by the channel estimator 358. The soft decisions are then decoded and deinterleaved to recover the data and control signals that were originally transmitted by the backscattering-based communications device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the backscattering-based communications device 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the backscattering-based communications device 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the backscattering-based communications device 310 in a manner similar to that described in connection with the receiver function at the wireless device 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the authentication transmission component 198 of FIG. 1.

At least one of the Tx processor 368, the Rx processor 356, and the controller/processor 359 may be configured to perform aspects in connection with the authentication reception component 199 of FIG. 1.

At least one of the Tx processor 316, the Rx processor 370, and the controller/processor 375 may be configured to perform aspects in connection with the authentication backscattering component 197 of FIG. 1.

FIG. 4 includes diagrams 400 and 410 illustrating example aspects of slot structures that may be used for sidelink communication (e.g., communication link 158 between UEs 104). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 4 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 400 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may include 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 410 in FIG. 4 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 4, some of the REs may include control information in PSCCH and some REs may include demodulation RS (DMRS). At least one symbol may be used for feedback. FIG. 4 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may include the data message described herein. The position of any of the data, DMRS, SCI, feedback, gap symbols, and/or LBT symbols may be different than the example illustrated in FIG. 4. Multiple slots may be aggregated together in some aspects.

Backscattering-based communications devices, such as RFID tags, may be configured to reflect and/or backscatter a wireless signal from a wireless communications device, such as a UE or a TRP of a base station. Such backscattering-based communications devices may be passive, active, semi-passive, and/or semi-active devices. A backscattering-based communications device may be an IoT device.

FIG. 5A is a diagram 510 illustrating an example of a wireless communications system having a wireless device 512 shown as device D1, a wireless device 514 shown as device D2, and a backscattering-based communications device 516 shown as a tag T that may reflect or backscatter a signal 513B from the wireless device 512 as a signal 517A to the wireless device 514. The wireless device 512 may be, for example, a UE, such as the UE 104 in FIG. 1, or a base station, such as the base station 102 in FIG. 1. Similarly, the wireless device 514 may be a UE, such as the UE 104 in FIG. 1, or a base station, such as the base station 102 in FIG. 1. The backscattering-based communications device 516 may be, for example, the backscattering-based communications device 106 in FIG. 1. The backscattering-based communications device 516 may be an RFID tag configured to process a command or a query from the wireless device 512, and may be configured to backscatter a signal with a response to the command or query.

The wireless device 512 may transmit a signal to the wireless device 514. The wireless device 512 may also transmit a signal 513B to the backscattering-based communications device 516. The signal 513A and the signal 513B may be the same signal received contemporaneously by both the wireless device 514 and the backscattering-based communications device 516. In other words, the wireless device 512 may be considered an RF source for both the signal 513A and the signal 513B. The wireless device 512 may transmit a continuous wave (CW), such as a sine wave. While the wireless device 512 and the wireless device 514 are depicted as two separate devices in the diagram 510, the wireless device 512 and the wireless device 514 may be a single full duplex (FD) UE that reads a reflected or backscattered signal from the backscattering-based communications device 516. In other words, while the wireless device 512 and the wireless device 514 may appear to be a bistatic wireless communication system with the wireless device 512 as a source UE transmitting a signal to the backscattering-based communications device 516 and the wireless device 514 as a receiver UE receiving a signal from the backscattering-based communications device 516, the wireless device 512 and the wireless device 514 may be a single UE in a monostatic wireless communications system.

The backscattering-based communications device 516 may reflect or backscatter the signal 513B as signal 517A to the wireless device 514. If the backscattering-based communications device 516 reflects the signal 513B as signal 517A to the wireless device 514, the signal 517A from the backscattering-based communications device 516 to the wireless device 514 may reinforce the signal 513A from the wireless device 512 to the wireless device 514, strengthening the signal received by the wireless device 514. If the backscattering-based communications device 516 backscatters the signal 513B as signal 517A to the wireless device 514, the signal 517A from the backscattering-based communications device 516 to the wireless device 514 may include an embedded signal (i.e., information bits) from the backscattering-based communications device in addition to the signal received by the wireless device 514. In other words, the backscattering-based communications device 516 may modulate the signal 513B with its data sequence. The wireless device 512 may send one or more queries to the backscattering-based communications device 516, and the backscattering-based communications device 516 may respond to one or more queries by transmitting a re-modulated signal as the signal 517A. The backscattering-based communications device 516 may transmit the signal 517A using any suitable resources, such as a CW resource. The CW resource may have a CW configuration having a single tone waveform, a multi-tone waveform, an OFDM waveform, or a single carrier (SC) waveform. The SC waveform may be, for example, a single carrier quadrature amplitude modulation (SC-QAM) waveform or a discrete Fourier transform spread orthogonal frequency division multiplexing (DFT-s-OFDM) waveform.

The backscattering-based communications device 516 may be a passive, an active, a semi-passive, or a semi-active IoT device. A passive IoT device may include an energy harvesting (EH) device configured to opportunistically harvest energy in the environment, such as solar, heat, and ambient RF. Such an EH device may have protocol enhancements that support one or more operations using intermittently available energy harvested from the environment. The passive IoT device may store harvested energy using a power storage unit, such as a capacitor or a supercapacitor, which may power RF components, such as the IC, an analog-to-digital converter (ADC), a mixer, and/or an oscillator. The passive IoT device may not have a battery. Variations on the amount of harvested energy and traffic may be expected using such devices. Passive IoT devices that operate using intermittently available energy harvested from the environment may not be able to sustain long, continuous transmission and/or reception. A semi-passive IoT device may have any of the capabilities of a passive IoT device, and may also have a power storage unit, such as a supercapacitor or a battery, that may power and/or turn on an IC of the device. A semi-passive IoT device may also reflect or backscatter an incident signal received by the passive IoT device.

A semi-active IoT device may have any of the capabilities of a passive or a semi-passive IoT device, and may also use its power storage unit to strengthen a received signal, for example by using a power amplifier (PA) that increases an amplitude of the reflected or backscattered signal. An active IoT device may have a power storage unit, such as a battery, that may provide power to one or more active RF components to transmit a signal even when the active IoT device is not within range to receive a signal. An active RF component may strengthen a received signal, for example by using a power amplifier (PA) that increases an amplitude of the reflected or backscattered signal. An active IoT device may even provide a reflected or backscattered signal that is stronger than the signal received by the device, such as the signal 513B received by the backscattering-based communications device 516. An active IoT device may also use its power storage unit to transmit a signal generated by the active IoT device that is not a reflected or a backscattered signal.

The backscattering-based communications device 516 may modulate an incident wave and/or signal using a data sequence. For example, the backscattering-based communications device 516 may use an amplitude shift keying (ASK) modulation method to switch on a reflection when transmitting an information bit “1” and switch off the reflection when transmitting an information bit “0.” For example, FIG. 5B is a diagram 520 illustrating an example of a radio wave transmitted by a wireless communications device, such as the wireless device 512 in FIG. 5A. FIG. 5C is a diagram 530 illustrating an example of a backscattered signal where the backscattering-based communications device, such as the backscattering-based communications device 516 in FIG. 5A, switches on a reflection when transmitting an information bit “1” and switches off the reflection when transmitting an information bit “0.” FIG. 5D is a diagram 540 illustrating an example of a signal received at a UE, such as the wireless device 514 in FIG. 5A, which may be a combination of a radio wave transmitted by a wireless communications device, such as the wireless device 512 in FIG. 5A, and a radio wave transmitted by a backscattering-based communications device, such as the backscattering-based communications device 516 in FIG. 5A.

Each radio wave may be denoted as x(n), such that h_{D1D2}(n) represents a radio wave from the wireless device 512 to the wireless device 514, h_{D1T}(n) represents a radio wave from the wireless device 512 to the backscattering-based communications device 516, and h_{TD2}(n) represents a radio wave from the backscattering-based communications device 516 to the wireless device 514. Diagram 520 in FIG. 5B shows a radio wave h_{D1D2}(n)/h_{D1T}(n) representing a radio wave transmitted by the wireless device 512 in FIG. 5A. The wireless device 514 may receive the radio wave as the signal 513A, denoted as h_{D1D2}(n), and the backscattering-based communications device 516 may receive the radio wave as the signal 513B, denoted as h_{D1T}(n).

The backscattering-based communications device 516 may use an ASK modulation method to switch on a reflection when transmitting an information bit “1” and switch off the reflection when transmitting an information bit “0.” The information bits of the backscattering-based communications device 516 may be denoted as s(n)∈{0,1}. Diagram 530 in FIG. 5C shows a radio wave σᵢh_{D1T}(n)h_{TD2}(n)s(n) representing a backscattered radio wave of the radio wave in diagram 520 in FIG. 5B, where the backscattering-based communications device 516 in FIG. 5A switches on reflection when transmitting an information bit “1” and switches off reflection when transmitting an information bit “0.” of may denote the reflection coefficient of the backscattering-based communications device 516. The backscattering-based communications device 516 may transmit the radio wave as the signal 517A, denoted as h_{TD2}(n), to the wireless device 514.

The wireless device 514 in FIG. 5A may receive a combination of the signal 513A, shown as the radio wave h_{D1D2}(n) in FIG. 5B, and the signal 517A, shown as the radio wave σᵢh_{D1T}(n)h_{TD2}(n)s(n) in FIG. 5C. Diagram 540 in FIG. 5C shows a radio wave h_{D1D2}(n)+σᵢh_{D1T}(n) h_{TD2}(n)s(n) representing the combination of the radio wave h_{D1D2}(n) of diagram 510 in FIG. 5B and the radio wave σᵢh_{D1T}(n)h_{TD2}(n)s(n) of diagram 520 in FIG. 5C. The wireless device 514 may then decode the combination radio wave to read the transmission from the wireless device 512, and also read information bits from the backscattering-based communications device 516. In other words, the wireless device 514 may estimate the envelope of the signal 517A, and the envelope may represent information bits from the backscattering-based communications device 516.

The complete signal received by the wireless device 514 in FIG. 5A may be represented by y(n)=(h_{D1D2}(n)+σᵢh_{D1T}(n)h_{TD2}(n)s(n))x(n)+noise, where noise represents signals received from other wireless devices using resources that overlap the transmissions from the wireless device 512 and the backscattering-based communications device 516. When s(n)=0, the backscattering-based communications device 516 may switch off reflection, so that the wireless device 514 only receives the direct link signal as signal 513A from the wireless device 512, represented by y(n)=h_{D1D2}(n)x(n)+noise. When s(n)=1, the backscattering-based communications device 516 may switch on reflection, so that the wireless device 514 receives the superposition of both the direct link signal as signal 513A from the wireless device 512 and the backscatter link signal as signal 517A from the backscattering-based communications device 516, represented by y(n)=(h_{D1D2}(n)+σᵢh_{D1T}(n)h_{TD2}(n)s(n))x(n)+noise.

Sidelink communication may be based on different types or modes of resource allocation mechanisms. In a first resource allocation mode (which may be referred to herein as “Mode 1”), centralized resource allocation may be provided by a network entity. For example, a base station may determine resources for sidelink communication and may allocate resources to different UEs to use for sidelink transmissions. In this first mode, a UE receives the allocation of sidelink resources from the base station. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots (discussed below).

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation mode 2, the UE may determine (e.g., sense) whether the selected sidelink resource has been reserved by other UE(s) before selecting a sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

The backscattering-based communications device 516 may have limited security when receiving the signal 513A or when transmitting the signal 517A. For example, in one aspect, the backscattering-based communications device 516 may have no security to transmit or receive signals. In another aspect, the backscattering-based communications device 516 may have a simple password that accompanies a command or a query that the backscattering-based communications device 516 may use to authenticate a device, such as the wireless device 512, transmitting a signal to the backscattering-based communications device. A backscattering-based communications device 516 with limited security may be easily spoofed by a fake tag. A backscattering-based communications device 516 with a higher level of security when receiving the signal 513A or when transmitting the signal 517A, may be more difficult to spoof.

In one aspect, a first wireless device, such as the wireless device 512 in FIG. 5A, may be configured to transmit a first public key to a backscattering-based communications device. The first wireless device may be configured to transmit an unsigned transmission to the backscattering-based communications device. The first wireless device may be configured to transmit a signed transmission to the backscattering-based communications device.

A second wireless device, such as the wireless device 514 in FIG. 5A, may be configured to receive a configuration of a backscattering-based communications device from a first wireless device. The second wireless device may be configured to receive a backscattered signal from the backscattering-based communications device. The second wireless device may be configured to transmit a first detected error to the first wireless device in response to detecting an error in the backscattered signal based on the configuration of the backscattering-based communications device.

A backscattering-based communication device, such as the backscattering-based communications device 516 in FIG. 5A, may be configured to receive a first public key from a first wireless device. The backscattering-based communication device may be configured to receive an unsigned transmission from the first wireless device. The backscattering-based communication device may be configured to receive a signed transmission from the first wireless device. The backscattering-based communication device may be configured to process the unsigned transmission in response to verifying the signed transmission based on the first public key.

FIG. 6A is a diagram 610 illustrating an example of a bistatic wireless communications system having a wireless device 612 configured to transmit a signal 613B to a backscattering-based communications device 616, which may then transmit a signal 617A to the wireless device 614. The signal 613B may also be received by the wireless device 614 as signal 613A, may also be received by the fake backscattering-based communications device 618 as signal 613C, and may also be received by the fake wireless device 620 as signal 613D.

The fake backscattering-based communications device 618 may attempt to fool the wireless device 614 into thinking that it is the backscattering-based communications device 616 by transmitting the signal 617B. If the backscattering-based communications device 616 has limited security, such as only a password that is sent with commands or queries from the wireless device 612 to the backscattering-based communications device 616, the fake backscattering-based communications device 618 may easily fool the wireless device 614 into thinking that it is the backscattering-based communications device 616 by transmitting the signal 617B.

The fake wireless device 620 may attempt to fool the backscattering-based communications device 616 into thinking that it is the wireless device 612 by transmitting the signal 613E. If the backscattering-based communications device 616 has limited security, such as only a password that is sent with commands or queries from the wireless device 612 to the backscattering-based communications device 616, the fake wireless device 620 may easily fool the backscattering-based communications device 616 into thinking that it is the wireless device 612 by transmitting the signal 613E, which spoofs the signal 613D. The fake wireless device 620 may be able to derive the password to the backscattering-based communications device 616 by analyzing the signal 613D, and my substitute its own command or query in the signal 613E using the password derived from the signal 613D.

In one aspect, the backscattering-based communications device 616 may be configured to process a signature at a PHY layer when receiving the signal 613B from the wireless device 612. The backscattering-based communications device 616 may be configured to maintain authentication and integrity of the signal 613B from the wireless device 612 to ensure that the signal 613B is received from the wireless device 612, and not from a fake wireless device, such as the fake wireless device 620 that may transmit the signal 613E to the backscattering-based communications device 616. The wireless device 612 may sign one or more transmissions to the backscattering-based communications device 616, such as a command to the backscattering-based communications device 616 or a query to the backscattering-based communications device 616. The signature may also be authenticated by tracking one or more attributes of the wireless device 612 to maintain authentication, such as a position of the wireless device 612. In one aspect, the backscattering-based communications device 616 may be configured to track a position of the wireless device 612 to maintain authentication with the wireless device 612. For example, the wireless device 612 may transmit a position indicator (e.g., a zone ID, a GNSS position indicator) with the signal 613B, and if the position indicator that the backscattering-based communications device 616 receives moves by a threshold distance or by at least the threshold distance from the previous position indicator, the backscattering-based communications device 616 may detect an error in authentication of the signature. In another example, the backscattering-based communications device 616 may measure an RSRP of the signal 613B to estimate a distance of the wireless device 612 from the backscattering-based communications device 616. If the RSRP of a subsequent received signal differs from the RSRP of the previously received signal by a threshold amount, or by at least the threshold amount, the backscattering-based communications device 616 may detect an error in authentication of the signature. In response to detecting the error, the backscattering-based communications device 616 may not process the received signal (e.g., may not process a received command or a received query), or may transmit a message indicating that an error has been detected to the wireless device 612 or to the wireless device 614.

In one aspect, the wireless device 614 may be configured to process a signature at a PHY layer when receiving the signal 617B from the backscattering-based communications device 616. The wireless device 614 may be configured to maintain authentication and integrity of the signal 617A from the backscattering-based communications device 616 to ensure that the signal 617A is received from the backscattering-based communications device 616, and not from a fake wireless device, such as the fake backscattering-based communications device 618 that may transmit the signal 617B to the wireless device 614. The backscattering-based communications device 616 may sign one or more payloads to the wireless device 614, such as a response to a command from the wireless device 612 or a response to a query from the wireless device 612. The signature may also be authenticated by tracking one or more attributes of the backscattering-based communications device 616 to maintain authentication, such as a position of the backscattering-based communications device 616. In one aspect, the wireless device 614 may be configured to track a position of the backscattering-based communications device 616 to maintain authentication with the backscattering-based communications device 616. For example, the backscattering-based communications device 616 may transmit a position indicator (e.g., a zone ID, a GNSS position indicator) with the signal 617A, and if the position indicator that the wireless device 614 receives moves by a threshold distance or by at least the threshold distance from the previous position indicator, the wireless device 614 may detect an error in authentication of the signature. As the backscattering-based communications device 616 may be configured to be stationary (e.g., affixed to a surface), the threshold distance may be a lower value as compared to a threshold distance used for a mobile wireless device, such as a UE. In another example, the wireless device 614 may measure an RSRP of the signal 617A to estimate a distance of the backscattering-based communications device 616 from the wireless device 614. If the RSRP of a subsequent received signal differs from the RSRP of the previously received signal by a threshold amount, or by at least the threshold amount, the wireless device 614 may detect an error in authentication of the signature. In response to detecting the error, the wireless device 614 may transmit a message indicating that an error has been detected to the backscattering-based communications device 616 or to the wireless device 612.

In one aspect, the wireless device 612 may be configured to sign one or more unsigned transmissions to the backscattering-based communications device 616. An unsigned transmission may be a transmission having a signal Signing the one or more unsigned transmissions to the backscattering-based communications device 616 may enable the backscattering-based communications device 616 to verify whether the one or more unsigned transmissions are validly from the wireless device 612 or are invalidly from a false device, such as the fake wireless device 620. The wireless device 612 may be configured to generate a private key and public key, and may transmit the public key to devices that will use the public key. For example, the wireless device 612 may broadcast the public key as the signal 613B to the backscattering-based communications device 616 and as the signal 613A to the wireless device 614. The wireless device 612 may generate a signed transmission using the private key and may transmit the signed transmission to the backscattering-based communications device 616. The signed transmission may be transmitted to a device that receives the unsigned transmission, such as the backscattering-based communications device 616 or the wireless device 614. In one aspect, the wireless device 612 may hash a signal, such as one or more commands and/or queries, and then may sign the hashed signal using the private key.

A device receiving the signed transmission from the wireless device 612, such as the backscattering-based communications device 616 or the wireless device 614, may check if the signature is valid by using the public key previously received from the wireless device 612. In other words, the backscattering-based communications device 616 and/or the wireless device 614 may be configured to verify a signed transmission to determine if an unsigned transmission was from the wireless device 612. In some aspects, the backscattering-based communications device 616 and the wireless device 614 may use the same public key to validate one or more transmissions from the wireless device 612. In other aspects, the backscattering-based communications device 616 and the wireless device 614 may use different public keys to validate one or more transmissions from the wireless device 612. In such an aspect, the wireless device 612 may transmit a first public key to the backscattering-based communications device 616 and may transmit a second, different, public key to the wireless device 614. The wireless device 612 may also transmit different signed transmissions to the backscattering-based communications device 616 and the wireless device 614, respectively, enabling different methods of authentication to authenticate the same set of unsigned transmissions at the backscattering-based communications device 616 and the wireless device 614, respectively.

In one aspect, the signed transmission may be multiplexed with the unsigned transmission. For example, the unsigned transmission may include a command or a query to the backscattering-based communications device 616, and the signed transmission may be a portion of the command or query signed using the private key and multiplexed with the unsigned transmission. The multiplexed transmission may then be transmitted to the backscattering-based communications device 616 as the signal 613B. In one aspect, the wireless device 612 may be configured to transmit an unsigned transmission to the backscattering-based communications device 616 and, after a period of time has passed, transmit a signed transmission to the backscattering-based communications device 616. The period of time may be configured in a plurality of ways, for example by an RRC configuration or a previous transmission from the wireless device 612, such as the transmission that included the public key. The backscattering-based communications device 616 may then verify that the unsigned transmission is valid by verifying the signed transmission that was received by the backscattering-based communications device 616 a period of time after the unsigned transmission was received by the backscattering-based communications device 616. In one aspect, the wireless device 612 may be configured to transmit a signature to the backscattering-based communications device 616 after a number of unsigned transmissions have been transmitted to the backscattering-based communications device 616, for example after five or after ten unsigned transmissions. This may reduce the payload size of the signal 613B transmitted from the wireless device 612 to the backscattering-based communications device 616. In another aspect, the wireless device 612 may be configured to transmit a set of signatures to the backscattering-based communications device 616 after a number of unsigned transmissions have been transmitted to the backscattering-based communications device 616, where each signature is associated with a set of unsigned transmissions to authenticate. The wireless device 612 may transmit the signature a period of time after the number of unsigned transmissions have been transmitted by the wireless device 612.

In some aspects, the backscattering-based communications device 616 may be configured to request a signature from the wireless device 612. For example, in response to the backscattering-based communications device 616 receiving a threshold number of unsigned transmissions, or in response to the backscattering-based communications device 616 receiving an unsigned transmission without receiving a signature within a threshold amount of time, the backscattering-based communications device 616 may transmit a request to the wireless device 612 for a signature to verify the one or more unsigned transmissions received by the backscattering-based communications device 616 before processing the one or more unsigned transmissions. The backscattering-based communications device 616 may use an amount of time to verify the signed transmission. The wireless device 612 may wait the amount of time after transmitting the signed transmission before transmitting another transmission to the backscattering-based communications device 616. In another aspect, the wireless device 612 may monitor for an incoming transmission from the backscattering-based communications device 616, such as an acknowledgement (ACK) or a negative ACK (NACK) to a command transmitted to the backscattering-based communications device 616. The backscattering-based communications device 616 may respond to an authentication of a signature in a plurality of ways. In one aspect, the backscattering-based communications device 616 may not process one or more unsigned transmissions until a signed transmission has been verified. In one aspect, the backscattering-based communications device 616 may transmit a verification of one or more unsigned transmissions to the wireless device 612 upon verifying the signed transmission associated with the one or more unsigned transmissions. In one aspect, the backscattering-based communications device 616 may transmit a verification of one or more unsigned transmissions to the wireless device 612 upon receiving a request from the wireless device 612 to transmit the verification.

The backscattering-based communications device 616 may transmit a capability to the wireless device 612 of a threshold amount of time to wait after transmitting a signed transmission before transmitting another transmission to the backscattering-based communications device 616. The capability may be, for example, an RFID capability. In some aspects, the wireless device 612 may request a capability from the backscattering-based communications device 616 to configure an authentication procedure. The capability may include, for example, a capability to authenticate unsigned transmissions, such as commands and/or queries, an amount of time to process a signed transmission, a capability to authenticate a type of signed transmission (e.g., a multiplexed signed transmission, a signed transmission transmitted a period of time after an unsigned transmission, a signed transmission transmitted after a number of unsigned transmissions), or a capability to authenticate a signed transmission in a type of way (e.g., processing one or more unsigned transmissions after authentication, transmitting a verification of one or more unsigned transmissions to the wireless device 612, transmitting a verification upon request from the wireless device 612). The capability may include one or more parameters of the capability. For example, a capability of the backscattering-based communications device 616 to authenticate a signed transmission may include a period of time used to process the signed transmission, or a capability to transmit a verification of a signed transmission may include a period of time after receiving one or more signed transmissions or a number of signed transmissions to verify before transmitting the verification.

In some aspects, the wireless device 614 may alternatively or additionally monitor the unsigned transmissions and signatures transmitted by the wireless device 612 to the backscattering-based communications device 616 to verify the unsigned transmissions. If the wireless device 614 detects an error, the wireless device 614 may transmit an indication of the detected error to the wireless device 612, or to a network node (e.g., a base station, a gNB) serving the wireless device 612. In such an aspect, the backscattering-based communications device 616 need not authenticate transmissions from the wireless device 612. In response to receiving an indication of a detected error, the network node serving the wireless device 612 may send a transmission to the backscattering-based communications device 616 (directly or via the wireless device 612) to ignore a set of previous communications or send communications with a higher level of security (e.g., longer key). In another aspect, in response to receiving an indication of a detected error, the network node serving the wireless device 612 may transmit a kill password to the backscattering-based communications device 616 to stop communication with the backscattering-based communications device 616, and transmit an access password to the backscattering-based communications device 616 to re-establish communication. In another aspect, if the backscattering-based communications device 616 is part of a UE, in response to receiving an indication of a detected error, the network node serving the wireless device 612 may instruct the backscattering-based communications device 616 to use the main radio of the UE in lieu of using backscattering-based communication.

Alternatively, or additionally, the wireless device 612 and/or the wireless device 614 may be configured to authenticate one or more transmissions from the backscattering-based communications device 616, such as a backscattered transmission of a response to a command or a query from the wireless device 612. The authentication at the wireless device 612 or the wireless device 614 may be similar to the authentication at the backscattering-based communications device 616. For example, the authentication at the wireless device 612 or the wireless device 614 may be at a PHY layer when receiving the signal 617A to verify that the signal 617A comes from the backscattering-based communications device 616 and not a fake wireless device, such as the fake backscattering-based communications device 618 transmitting the signal 617B. The backscattering-based communications device 616 may transmit one or more unsigned transmissions of responses to commands and/or queries from the wireless device 612, and may use a private key and a public key to enable the wireless device 614 to authenticate the transmissions of the signal 617A. The backscattering-based communications device 616 may sign a command or a portion of a command to indicate that the command has been received and processed by the backscattering-based communications device 616. From the signature, the wireless device 612 or the wireless device 614 may determine that the backscattering-based communications device 616 is authenticated. If the wireless device 614 detects an error, the wireless device 614 may transmit an indication of the detected error to the backscattering-based communications device 616, to the wireless device 612, or to a network node serving the wireless device 612. In some aspects, the backscattering-based communications device 616 may transmit a signature in response to receiving a request to transmit a signature from the wireless device 612 or the wireless device 614. In other words, the wireless device 612 or the wireless device 614 may seek to verify the backscattering-based communications device 616 by transmitting a request for a signed transmission to the backscattering-based communications device 616.

In some aspects, the verification may also include monitoring parameters of one or more of the unsigned transmissions or the signed transmissions from the backscattering-based communications device 616. In one aspect, the backscattering-based communications device 616 may be configured to add a time offset or a frequency offset to read the signal 613B from the wireless device 612 or to transmit the signal 617A to the wireless device 614. In other words, the backscattering-based communications device 616 may be configured to add a time offset or frequency offset to authenticate a command that is received by the backscattering-based communications device 616 or a response to the command transmitted by the backscattering-based communications device 616 to maintain authenticity. The time offset or frequency offset may be indicated to the backscattering-based communications device 616 by the wireless device 612 or may be RRC configured. In another aspect, the codebook for sequence or channel coding of the signal 617A may be used to authenticate the backscattering-based communications device 616, as the codebook may dictate when the backscattering-based communications device 616 switches on a reflection when transmitting an information bit “1” and switches off the reflection when transmitting an information bit “0.” The codebook may be configured by the wireless device 612, by a network node, or may be provided as a capability of the backscattering-based communications device 616. In another aspect, the backscattering-based communications device 616 may be configured to add a frequency and/or phase to the signal 617A based on a configuration from the wireless device 612. In another aspect, the backscattering-based communications device 616 may be configured to change an angle of departure (AoD) of the signal 617A based on a configuration from the wireless device 612. In another aspect, a position indicator of the backscattering-based communications device 616 may be used to authenticate the signal 617A. The position indicator may be, for example, a zone ID, a GNSS position indicator, or a measured RSRP of the signal 617A.

FIG. 6B is a diagram 650 illustrating an example of a monostatic wireless communications system having a wireless device 612 configured to transmit a signal 613B to a backscattering-based communications device 616, which may then transmit a signal 619A back to the wireless device 612. The wireless device 612 and the backscattering-based communications device 616 may operate in full duplex (FD) mode to transmit and receive the signals 613B and 619A with one another. The signal 613B may also be received by the fake backscattering-based communications device 618 as signal 613C, and may also be received by the fake wireless device 620 as signal 613D.

The fake backscattering-based communications device 618 may attempt to fool the wireless device 612 into thinking that it is the backscattering-based communications device 616 by transmitting the signal 619B. If the backscattering-based communications device 616 has limited security, such as only a password that is sent with commands or queries from the wireless device 612 to the backscattering-based communications device 616, the fake backscattering-based communications device 618 may easily fool the wireless device 612 into thinking that it is the backscattering-based communications device 616 by transmitting the signal 619B.

The fake wireless device 620 may attempt to fool the backscattering-based communications device 616 into thinking that it is the wireless device 612 by transmitting the signal 613E. If the backscattering-based communications device 616 has limited security, such as only a password that is sent with commands or queries from the wireless device 612 to the backscattering-based communications device 616, the fake wireless device 620 may easily fool the backscattering-based communications device 616 into thinking that it is the wireless device 612 by transmitting the signal 613E, which spoofs the signal 613D. The fake wireless device 620 may be able to derive the password to the backscattering-based communications device 616 by analyzing the signal 613D, and my substitute its own command or query in the signal 613E using the password derived from the signal 613D.

The wireless device 612 and the backscattering-based communications device 616 may be configured to use a higher level of security, as described above, to prevent a fake device, such as the fake wireless device 620 or the fake backscattering-based communications device 618, from successfully imitating signals from wireless device 612 and the backscattering-based communications device 616, respectively. For example, the backscattering-based communications device 616 may be configured to authenticate one or more signed transmissions from the wireless device 612. In response to detecting an error, the backscattering-based communications device 616 may transmit an indication of the error to the wireless device 612. Similarly, the wireless device 612 may be configured to authenticate one or more signed transmissions from the backscattering-based communications device 616. In response to detecting an error, the wireless device 612 may transmit an indication of the error to the backscattering-based communications device 616.

The wireless device 612 may be configured to sign any portion of an unsigned transmission, such as one or more commands or queries, one or more portions of one or more commands or queries (e.g., the first five bits of a set of commands or queries), a payload of the backscattering-based communications device 616 that is backscattered, one or more signaled IDs (e.g., an ID of a UE, an ID of a base station), or a time stamp. In one aspect, a commitment scheme for signing an unsigned transmission may use a plurality of parameters for the public key, such as the parameters p, g, and h, which may be shared on any suitable layer, for example a first network communication layer (e.g., PHY layer), a second network communication layer (e.g., MAC layer), or a third network communication layer (e.g., RLC layer). The parameter p may be a large prime number, the parameter g may be a number in [2, p−1], and the parameter h may be a number in [2, p−1] such that log_{g}h is unknown. The wireless device 612 may provide g^{1D}h^{r} mod p as a commitment of bits of the backscattering-based communications device 616 or a command/query to the backscattering-based communications device 616. In one aspect, the ID may be defined by the wireless device 612 as a scrambling ID associated with the second network communication layer or the third communication layer, or may be a combination of such a scrambling ID with a timestamp, a number of command bits for the backscattering-based communications device 616, a number of payload bits for the backscattering-based communications device 616, or a combination thereof. The parameter r may be a random number. The commitment of bits g^{1D}h^{r} mod p may be provided to the backscattering-based communications device 616 or to the wireless device 614 via any suitable layer, for example a first, second, or third network communication layer, and the wireless device 612 may broadcast the value of the parameter r as the public key. The backscattering-based communications device 616 or the wireless device 614 may verify the committed value after receiving the channel and the parameter r. Such a commitment scheme may be used to verify a signed package without needing to open the package. In other words, the commitment scheme may leverage zero-knowledge proof (ZKP) techniques based on the hardness of discrete log problems.

In one aspect, the wireless device 612 may have a private key x and a public value y=g^{x} mod p. The wireless device 612 may select a random integer for v and may computer t=g^{v}. The wireless device 612 may computer c=H (g,y,t,ID), where H( ) may be a cryptographic hash function and ID may be defined by the wireless device 612 as explained above. The wireless device 612 may compute r=v−cx, and the proof may be the pair (t, r); (g^{v}, v−cx). In response, the backscattering-based communications device 616 or the wireless device 614 may calculate c=H(g,y,t,ID) and verify the signed transmission by checking whether t=g^{r}g^{xc}=g^{v}. Such a commitment scheme may be flexible with secure operations. The wireless device 612 may calculate the value of c while a dedicated function that holds a secret value x that is never read may be used to compute (t, r). In some embodiments, more efficient signature schemes may be used, for example a Boneh-Lynn-Shacham (BLS) signature based on bilinear pairing on EC that may use 256 bits.

In another embodiment, a timed efficient stream loss-tolerant algorithm (TESLA) commitment scheme may be used that uses a reverse hash chain. The wireless device 612 may create a hash chain of keys by using a repeated hash of a root key. In other words, Kᵢ₊₁=H(Kᵢ) where 1≤i≤n and H( ) may be a cryptographic hash function. The wireless device 612 may disclose one or more hash values, or public keys, in the reverse order of the calculation. For example, K(t=0)=Kₙ, K(t=1)=Kₙ₋₁, . . . , K(t=n−1)=K₁. In other words, if the wireless device 612 discloses two keys, one for the payload of backscattering-based communications device 616 and one for the command bits of backscattering-based communications device 616, then the wireless device 612 may assign one or more portions of the commands to Kᵢ₊₁ and the payload of the backscattering-based communications device 616 to Kᵢ. A command may have a key that is derived based on hash chain of keys such that the bits of the command may be later compared to the bits of the payload. The key may be provided later, and may be verified using the previously provided key. For example, the previous key K(t=i−1)=H(K(t=i)), and Kₙ₋ᵢ₊₁=H(Kₙ₋₁). While the first key value may need to be authenticated with the wireless device 612 (e.g., during registration or authentication server (AS) setup).

In one aspect, the backscattering-based communications device 616 may transmit a tag capability to the wireless device 612 or the wireless device 614 as part of an initial access procedure, for example indicated with one or more initial access messages. In one aspect, the backscattering-based communications device 616 may transmit a tag capability as a response to a capability query from the wireless device 612. In one aspect, the backscattering-based communications device 616 may transmit a tag capability using at least one of a level 1 indicator, level 2 indicator, or a level 3 indicator after RRC connection with a network entity. In one aspect, the backscattering-based communications device 616 may transmit a tag capability as part of a user assistance information (UAI) message.

In FIG. 7 a connection flow diagram 700 has a wireless device 702, a backscattering-based communications device 704, and a wireless device 706 similar to the wireless device 612, the backscattering-based communications device 616, and the wireless device 614 in FIG. 6A, respectively. At 712, the wireless device 702 may configure one or more transmissions to the backscattering-based communications device 704.

In one aspect, the wireless device 702 may configure one or more public and private keys for use with transmissions to the backscattering-based communications device 704. The wireless device 702 may transmit the one or more public keys as the one or more transmission configurations 714 to the backscattering-based communications device 704. The wireless device 702 may transmit the one or more public keys as the one or more transmission configurations 714 to the wireless device 706. In one aspect, the wireless device 702 may allocate one or more resources for the backscattering-based communications device 704, for example a frequency domain or a time domain for one or more transmissions of the backscattering-based communications device 704. The wireless device 702 may transmit the one or more allocated resources, or allocations, to the wireless device 706. The wireless device 706 may use the allocations to monitor one or more transmissions from the wireless device 702, such as the one or more unsigned transmissions 720 or the one or more signed transmissions 726.

At 713, the backscattering-based communications device 704 may configure one or more transmissions to the wireless device 706. In one aspect, the backscattering-based communications device 704 may configure one or more public and private keys for use with transmissions to the wireless device 706. The backscattering-based communications device 704 may transmit the one or more public keys as the one or more transmission configurations 716 to the wireless device 706.

At 718, the wireless device 702 may generate one or more unsigned transmissions 720. The one or more unsigned transmissions 720 may include one or more commands or one or more queries for the backscattering-based communications device 704. The one or more unsigned transmissions 720 may be encrypted, for example by using a public key or a symmetric key. The wireless device 702 may transmit the one or more unsigned transmissions 720 to the backscattering-based communications device 704. The wireless device 702 may transmit the one or more unsigned transmissions 720 to wireless device 706.

At 724, the wireless device 702 may generate a signed transmission. The wireless device 702 may be configured to transmit the one or more signed transmissions 726 to authenticate the one or more unsigned transmissions 720, such as a command or a query, with the backscattering-based communications device 704. A signed transmission may correspond with an unsigned transmission, a signed transmission may correspond with a set of unsigned transmissions, and a set of signed transmissions may correspond with a set of unsigned transmissions, where each of the set of signed transmissions correspond with a set of unsigned transmissions. The wireless device 702 may transmit the one or more signed transmissions 726 to the backscattering-based communications device 704. The wireless device 702 may transmit the one or more signed transmissions 726 to the wireless device 706. The backscattering-based communications device 704 may verify whether the wireless device 702 is valid based on the one or more signed transmissions 726. In one aspect, the one or more signed transmissions 726 may include a set of bits transmitted to the backscattering-based communications device 704 as a part of a command or query (e.g., a part of one or more unsigned transmissions 720) that is multiplexed to a payload of the backscattering-based communications device 704. In other words, the one or more signed transmissions 726 and one of the one or more unsigned transmissions 720 may be multiplexed with one another. In one aspect, the one or more signed transmissions 726 may include a set of bits transmitted to the backscattering-based communications device 704 as a separate signal to the one or more unsigned transmissions 720 after a time period from sending the unsigned transmission. In one aspect, the one or more signed transmissions 726 may include a set of bits transmitted to the backscattering-based communications device 704 as a signature that is transmitted after a number of commands are sent to the backscattering-based communications device 704 to reduce the total payload size of all transmissions to backscattering-based communications device 704 from the wireless device 702.

The one or more signed transmissions 726 may be signed using a private key generated at 712. The wireless device 702 may hash one or more unsigned transmissions 720, and may sign the hashed value using the private key. The one or more signed transmissions 726 may be transmitted to the backscattering-based communications device 704 from the wireless device 702.

At 728, the backscattering-based communications device 704 may check if the signature is valid using the public key, and may not process any commands or queries of the one or more unsigned transmissions 720 associated with the one or more signed transmissions 726 at 730 if the signature of the one or more signed transmissions 726 is not valid. The backscattering-based communications device 704 may transmit a request 722 to the wireless device 702 for a signed transmission. In one aspect, if the backscattering-based communications device 704 receives a number of unsigned transmissions without a signed transmission, or receives an unsigned transmission and does not receive a signed transmission within a threshold period of time, the backscattering-based communications device 704 may transmit a request 722 to the wireless device 702 for a signed transmission.

The one or more signed transmissions 726 may be transmitted to the wireless device 706. At 734, the wireless device 706 may check if the signature of the one or more signed transmissions 726 is valid using the public key received in the one or more transmission configurations 714, and may transmit a message of one or more detected errors 736 to the wireless device 702 or to the backscattering-based communications device 704 if the wireless device 706 determines that the signature is not valid.

At 730, the backscattering-based communications device 704 may process the one or more unsigned transmissions 720 in response to validating the one or more signed transmissions 726. For example, the backscattering-based communications device 704 may process a command, or may process a query. In response, the backscattering-based communications device 704 may transmit one or more backscattered transmissions 732 to the wireless device 706, for example a response to a query. The one or more backscattered transmissions 732 may be a combination of the response with a continuous wave signal received from the wireless device 702.

In one aspect, the backscattering-based communications device 704 may be a passive tag that uses received power from a signal to power its processor, such as an integrated circuit (IC). In another aspect, the backscattering-based communications device 704 may be an active tag that has a battery that the backscattering-based communications device 704 may use to power a processor. In another aspect, the backscattering-based communications device 704 may be a tag radio of a UE. Such a UE may have a plurality of radios, such as an LTE radio and an NR radio in a multi-radio (MR) mode. Such a UE may use the tag radio, otherwise referred to as the backscattering-based communications device 704, in a low power state or in a sleep mode. Such a UE may receive an indication from the wireless device 702 as part of the one or more transmission configurations 714 to operate the tag radio of the backscattering-based communications device 704. The indication may be transmitted in response to receiving an indication of one or more detected errors 736. Such a UE may generate and store public and private keys during an MR ON mode, and may use the keys for backscattering-based communications during an MR OFF mode. During an MR ON mode, the UE may encrypt or sign transmissions rapidly, and backscattering-based communication may be performed using the backscattering-based communications device 704. When the UE is in MR ON mode, the UE may track positioning or a zone ID of the UE, or perform positioning measurements to assist in tracking position information of the backscattering-based communications device 704. Such a UE may indicate a tag capability of the backscattering-based communications device 704, or may indicate a tag capability in its UE capability provided to a network entity, such as wireless device 702. The tag capability may include an indication of the ability of the backscattering-based communications device 704 to generate keys or apply the proposed methods when MR is off at the UE, or when MR is not used at the UE.

FIG. 8 is a flowchart 800 of a method of wireless communication. The method may be performed by a first wireless device (e.g., the UE 104; the wireless device 350, the wireless device 512, the wireless device 514, the wireless device 612, the wireless device 614, the wireless device 702, the wireless device 706; the apparatus 1104). At 802, the first wireless device may transmit a first public key to a backscattering-based communications device. For example, 802 may be performed by the wireless device 702 in FIG. 7, which may transmit a first public key as the one or more transmission configurations 714 to the backscattering-based communications device 704. Moreover, 802 may be performed by the component 198 in the apparatus 1104 in FIG. 11.

At 804, the first wireless device may transmit an unsigned transmission to the backscattering-based communications device. For example, 804 may be performed by the wireless device 702 in FIG. 7, which may transmit one or more unsigned transmissions 720 to the backscattering-based communications device 704. Moreover, 802 may be performed by the component 198 in the apparatus 1104 in FIG. 11.

At 806, the first wireless device may transmit a signed transmission to the backscattering-based communications device. The signed transmission may be signed based on a first private key. For example, 806 may be performed by the wireless device 702 in FIG. 7, which may transmit one or more signed transmissions 726 to the backscattering-based communications device 704. Moreover, 802 may be performed by the component 198 in the apparatus 1104 in FIG. 11.

FIG. 9 is a flowchart 900 of a method of wireless communication. The method may be performed by a first wireless device (e.g., the UE 104; the wireless device 350, the wireless device 512, the wireless device 514, the wireless device 612, the wireless device 614, the wireless device 702, the wireless device 706; the apparatus 1104). At 902, the first wireless device may receive a configuration of a backscattering-based communications device from a first wireless device. For example, 902 may be performed by the wireless device 706 in FIG. 7, which may receive a configuration as the one or more transmission configurations 714 of the backscattering-based communications device 704 from the wireless device 702. Moreover, 902 may be performed by the component 199 in the apparatus 1104 in FIG. 11.

At 904, the first wireless device may receive a backscattered signal from the backscattering-based communications device. For example, 904 may be performed by the wireless device 706 in FIG. 7, which may receive one or more backscattered transmissions 732 from the backscattering-based communications device 704. Moreover, 902 may be performed by the component 199 in the apparatus 1104 in FIG. 11.

At 906, the first wireless device may transmit a first detected error to the first wireless device in response to detecting an error in the backscattered signal based on the configuration of the backscattering-based communications device. For example, 906 may be performed by the wireless device 706 in FIG. 7, which may transmit one or more detected errors 736 to the wireless device 702 in response to detecting an error in the one or more backscattered transmissions 732 at 734. The error may be detected based on the one or more transmission configurations 714. Moreover, 902 may be performed by the component 199 in the apparatus 1104 in FIG. 11.

FIG. 10 is a flowchart 1000 of a method of wireless communication. The method may be performed by a backscattering-based communications device (e.g., the backscattering-based communications device 106, 310, 516, 616, 704). At 1002, the backscattering-based communications device may receive a first public key from a first wireless device. For example, 1002 may be performed by the backscattering-based communications device 704 in FIG. 7, which may receive a first public key as the one or more transmission configurations 714 from the wireless device 702. Moreover, 1002 may be performed by the component 197 in the backscattering-based communications device 310 in FIG. 3.

At 1004, the backscattering-based communications device may receive an unsigned transmission from the first wireless device. For example, 1004 may be performed by the backscattering-based communications device 704 in FIG. 7, which may receive one or more unsigned transmissions 720 from the wireless device 702. Moreover, 1002 may be performed by the component 197 in the backscattering-based communications device 310 in FIG. 3.

At 1006, the backscattering-based communications device may receive a signed transmission from the first wireless device. For example, 1006 may be performed by the backscattering-based communications device 704 in FIG. 7, which may receive one or more signed transmissions 726 from the wireless device 702. Moreover, 1002 may be performed by the component 197 in the backscattering-based communications device 310 in FIG. 3.

At 1008, the backscattering-based communications device may process the unsigned transmission in response to verifying the signed transmission based on the first public key. For example, 1008 may be performed by the backscattering-based communications device 704 in FIG. 7, which may process the unsigned transmission at 730 in response to verifying the signed transmission at 728 based on the first public key received in the one or more transmission configurations 714. Moreover, 1002 may be performed by the component 197 in the backscattering-based communications device 310 in FIG. 3.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (Rx)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the wireless device 350 and may include the memory 360 and/or at least one of the Tx processor 368, the Rx processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see wireless device 350 of FIG. 3) and include the additional modules of the apparatus 1104.

As discussed supra, the component 198 is configured to transmit a first public key to a backscattering-based communications device. The component 198 may be configured to transmit an unsigned transmission to the backscattering-based communications device. The component 198 may be configured to transmit a signed transmission to the backscattering-based communications device. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for transmitting a first public key to a backscattering-based communications device. The apparatus 1104 may include means for transmitting an unsigned transmission to the backscattering-based communications device. The apparatus 1104 may include means for transmitting a signed transmission to the backscattering-based communications device. The apparatus 1104 may include means for signing a portion of the unsigned transmission to generate the signed transmission. The apparatus 1104 may include means for multiplexing the signed transmission with the unsigned transmission to generate a payload for the backscattering-based communications device. The apparatus 1104 may include means for transmitting the unsigned transmission and transmitting the signed transmission by transmitting the payload to the backscattering-based communications device. The apparatus 1104 may include means for encrypting the unsigned transmission using at least one of a second public key or a first symmetric key. The apparatus 1104 may include means for hashing a portion of the unsigned transmission. The apparatus 1104 may include means for signing the hashed portion of the unsigned transmission to generate the signed transmission. The apparatus 1104 may include means for signing a signal that does not comprise a portion of the unsigned transmission to generate the signed transmission. The apparatus 1104 may include means for transmitting the signed transmission by transmitting the signed transmission after a time period from transmitting the unsigned transmission. The apparatus 1104 may include means for transmitting the signed transmission by transmitting the signed transmission after a plurality of unsigned transmissions have been transmitted to the backscattering-based communications device. The apparatus 1104 may include means for receiving a request for the signed transmission from the backscattering-based communications device. The apparatus 1104 may include means for transmitting the signed transmission in response to the request for the signed transmission. The means may be the component 198 of the apparatus 1104 configured to perform the functions recited by the means. As described supra, the apparatus 1104 may include the Tx processor 368, the Rx processor 356, and the controller/processor 359. As such, in one configuration, the means may be the Tx processor 368, the Rx processor 356, and/or the controller/processor 359 configured to perform the functions recited by the means.

As discussed supra, the component 199 is configured to receive a configuration of a backscattering-based communications device from a first wireless device. The component 199 may be configured to receive a backscattered signal from the backscattering-based communications device. The component 199 may be configured to transmit a first detected error to the first wireless device in response to detecting an error in the backscattered signal based on the configuration of the backscattering-based communications device. The component 199 may be within the cellular baseband processor 1124, the application processor 1106, or both the cellular baseband processor 1124 and the application processor 1106. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for receiving a configuration of a backscattering-based communications device from a first wireless device. The apparatus 1104 may include means for receiving a backscattered signal from the backscattering-based communications device. The apparatus 1104 may include means for transmitting a first detected error to the first wireless device in response to detecting an error in the backscattered signal based on the configuration of the backscattering-based communications device. The apparatus 1104 may include means for receiving a first public key from the first wireless device. The apparatus 1104 may include means for receiving a signed transmission from the first wireless device. The apparatus 1104 may include means for transmitting a second detected error to the first wireless device in response to detecting an error in the signed transmission based on the first public key. The apparatus 1104 may include means for receiving a second public key from the backscattering-based communications device. The apparatus 1104 may include means for transmitting a second detected error to the first wireless device in response to detecting an error in the signature based on the second public key. The apparatus 1104 may include means for detecting the error in the backscattered signal by detecting the error in the backscattered signal based on at least one of (a) a time domain offset applied to the backscattered signal, (b) a frequency domain offset applied to the backscattered signal, (c) a codebook applied to the backscattered signal, (d) an angle of departure (AoD) offset applied to the backscattered signal, or (e) a position indicator associated with the backscattered signal. The means may be the component 199 of the apparatus 1104 configured to perform the functions recited by the means. As described supra, the apparatus 1104 may include the Tx processor 368, the Rx processor 356, and the controller/processor 359. As such, in one configuration, the means may be the Tx processor 368, the Rx processor 356, and/or the controller/processor 359 configured to perform the functions recited by the means.

As discussed supra, the component 197 in FIG. 3 may be configured to receive a first public key from a first wireless device. The component 197 may be configured to receive an unsigned transmission from the first wireless device. The component 197 may be configured to receive a signed transmission from the first wireless device. The component 197 may be configured to process the unsigned transmission in response to verifying the signed transmission based on the first public key. The component 197 may be within the Tx processor 316, the Rx processor 370, or both the Tx processor 316 and the Rx processor 370. The component 197 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the backscattering-based communications device 310 may include a variety of components configured for various functions. In one configuration, the backscattering-based communications device 310, and in particular the Tx processor 316 and/or the Rx processor 370, may include means for receiving a first public key from a first wireless device. The backscattering-based communications device 310 may include means for receiving an unsigned transmission from the first wireless device. The backscattering-based communications device 310 may include means for receiving a signed transmission from the first wireless device. The backscattering-based communications device 310 may include means for processing the unsigned transmission in response to verifying the signed transmission based on the first public key. The backscattering-based communications device 310 may include means for transmitting a verification of the signed transmission in response to verifying the signed transmission based on the first public key. The backscattering-based communications device 310 may include means for receiving a set of signed transmissions from the first wireless device. The backscattering-based communications device 310 may include means for transmitting the verification of the signed transmission by transmitting a second verification of a plurality of signed transmissions including the signed transmission and the set of signed transmissions. The backscattering-based communications device 310 may include means for decoding the unsigned transmission using at least one of a second private key or a first symmetric key. The backscattering-based communications device 310 may include means for transmitting an RFID capability. The backscattering-based communications device 310 may include means for transmitting a request for the signed transmission to the first wireless device. The backscattering-based communications device 310 may include means for processing the unsigned transmission by transmitting a response to a query of the unsigned transmission. The backscattering-based communications device 310 may include means for transmitting a second public key. The backscattering-based communications device 310 may include means for signing the response to the query based on a second private key before transmitting the response to the query. The backscattering-based communications device 310 may include means for processing the unsigned transmission may include backscattering a command of the unsigned transmission. The backscattering-based communications device 310 may include means for transmitting a second public key. The backscattering-based communications device 310 may include means for signing the command based on a second private key before backscattering the command of the unsigned transmission. The backscattering-based communications device 310 may include means for verifying the signed transmission by verifying the signed transmission based on at least one of (a) a time domain offset applied to the signed transmission, (b) a frequency domain offset applied to the signed transmission, or (c) a codebook applied to the signed transmission. The means may be the component 197 of the backscattering-based communications device 310 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.

Aspect 1 is a method of wireless communication at a UE, where the method may include transmitting a first public key to a backscattering-based communications device. The method may include transmitting an unsigned transmission to the backscattering-based communications device. The method may include transmitting a signed transmission to the backscattering-based communications device. The signed transmission may be signed based on a first private key.

Aspect 2 is the method of aspect 1, where the method may include signing a portion of the unsigned transmission to generate the signed transmission.

Aspect 3 is the method of aspect 2, where the method may include multiplexing the signed transmission with the unsigned transmission to generate a payload for the backscattering-based communications device. Transmitting the unsigned transmission and transmitting the signed transmission may include transmitting the payload to the backscattering-based communications device.

Aspect 4 is the method of any of aspects 1 to 3, where the method may include encrypting the unsigned transmission using at least one of a second public key or a first symmetric key.

Aspect 5 is the method of any of aspects 1 to 4, where the method may include hashing a portion of the unsigned transmission. The method may include signing the hashed portion of the unsigned transmission to generate the signed transmission.

Aspect 6 is the method of any of aspects 1 to 5, where the method may include signing a signal that does not comprise a portion of the unsigned transmission to generate the signed transmission.

Aspect 7 is the method of aspect 6, where transmitting the signed transmission may include transmitting the signed transmission after a time period from transmitting the unsigned transmission.

Aspect 8 is the method of any of aspects 1 to 7, where transmitting the signed transmission may include transmitting the signed transmission after a plurality of unsigned transmissions have been transmitted to the backscattering-based communications device. The plurality of unsigned transmissions may include the unsigned transmission.

Aspect 9 is the method of any of aspects 1 to 8, where the method may include receiving a request for the signed transmission from the backscattering-based communications device. Transmitting the signed transmission may be in response to the request for the signed transmission.

Aspect 10 is a method of communication at a second wireless device, where the method may include receiving a configuration of a backscattering-based communications device from a first wireless device. The method may include receiving a backscattered signal from the backscattering-based communications device. The method may include transmitting a first detected error to the first wireless device in response to detecting an error in the backscattered signal based on the configuration of the backscattering-based communications device.

Aspect 11 is the method of aspect 10, where the method may include receiving a first public key from the first wireless device. The method may include receiving a signed transmission from the first wireless device. The method may include transmitting a second detected error to the first wireless device in response to detecting an error in the signed transmission based on the first public key.

Aspect 12 is the method of any of aspects 10 to 11, where the method may include receiving a second public key from the backscattering-based communications device. The backscattered signal may include a signature. The method may include transmitting a second detected error to the first wireless device in response to detecting an error in the signature based on the second public key.

Aspect 13 is the method of any of aspects 10 to 12, where detecting the error in the backscattered signal may further include detecting the error in the backscattered signal based on at least one of (a) a time domain offset applied to the backscattered signal, (b) a frequency domain offset applied to the backscattered signal, (c) a codebook applied to the backscattered signal, (d) an angle of departure (AoD) offset applied to the backscattered signal, or (e) a position indicator associated with the backscattered signal.

Aspect 14 is a method of communication at a backscattering-based communications device, where the method may include receiving a first public key from a first wireless device. The method may include receiving an unsigned transmission from the first wireless device. The method may include receiving a signed transmission from the first wireless device. The method may include processing the unsigned transmission in response to verifying the signed transmission based on the first public key.

Aspect 15 is the method of aspect 14, where the method may include transmitting a verification of the signed transmission in response to verifying the signed transmission based on the first public key.

Aspect 16 is the method of aspect 15, where the method may include receiving a set of signed transmissions from the first wireless device. Transmitting the verification of the signed transmission may include transmitting a second verification of a plurality of signed transmissions including the signed transmission and the set of signed transmissions.

Aspect 17 is the method of any of aspects 14 to 16, where the method may include decoding the unsigned transmission using at least one of a second private key or a first symmetric key.

Aspect 18 is the method of any of aspects 1 to 17, where the method may include transmitting a radio frequency identification (RFID) capability. The RFID capability may include a time period between receiving a set of signed transmissions and transmitting a verification of the set of signed transmissions.

Aspect 19 is the method of any of aspects 14 to 18, where the method may include transmitting a request for the signed transmission to the first wireless device.

Aspect 20 is the method of any of aspects 14 to 19, where processing the unsigned transmission may include transmitting a response to a query of the unsigned transmission.

Aspect 21 is the method of aspect 20, where the method may include transmitting a second public key. The method may include signing the response to the query based on a second private key before transmitting the response to the query.

Aspect 22 is the method of any of aspects 14 to 21, where processing the unsigned transmission may include backscattering a command of the unsigned transmission.

Aspect 23 is the method of aspect 22, where the method may include transmitting a second public key. The method may include signing the command based on a second private key before backscattering the command of the unsigned transmission.

Aspect 24 is the method of any of aspects 14 to 23, where verifying the signed transmission may include verifying the signed transmission based on at least one of (a) a time domain offset applied to the signed transmission, (b) a frequency domain offset applied to the signed transmission, or (c) a codebook applied to the signed transmission.

Aspect 25 is an apparatus for wireless communication, including: a memory; and at least one processor coupled to the memory and, based at least in part on information stored in the memory, the at least one processor is configured to implement any of aspects 1 to 24.

Aspect 26 is the apparatus of aspect x, further including at least one of an antenna or a transceiver coupled to the at least one processor.

Aspect 27 is an apparatus for wireless communication including means for implementing any of aspects 1 to 24.

Aspect 28 is a computer-readable medium (e.g., a non-transitory computer-readable medium) storing computer executable code, where the code when executed by a processor causes the processor to implement any of aspects 1 to 24.

What is claimed is:

1. An apparatus for wireless communication at a first wireless device, comprising:
a memory; and
at least one processor coupled to the memory and, based at least in part on information stored in the memory, the at least one processor is configured to:
transmit a first public key to a backscattering-based communications device;
transmit an unsigned transmission to the backscattering-based communications device; and
transmit a signed transmission to the backscattering-based communications device, wherein the signed transmission is signed based on a first private key.

2. The apparatus of claim 1, wherein the at least one processor is further configured to:
sign a portion of the unsigned transmission to generate the signed transmission.

3. The apparatus of claim 2, wherein the at least one processor is further configured to:
multiplex the signed transmission with the unsigned transmission to generate a payload for the backscattering-based communications device, wherein transmitting the unsigned transmission and transmitting the signed transmission comprises transmitting the payload to the backscattering-based communications device.

4. The apparatus of claim 1, wherein the at least one processor is further configured to:
encrypt the unsigned transmission using at least one of a second public key or a first symmetric key.

5. The apparatus of claim 1, wherein the at least one processor is further configured to:
hash a portion of the unsigned transmission; and
sign the hashed portion of the unsigned transmission to generate the signed transmission.

6. The apparatus of claim 1, wherein the at least one processor is further configured to:
sign a signal that does not comprise a portion of the unsigned transmission to generate the signed transmission.

7. The apparatus of claim 6, wherein, to transmit the signed transmission, the at least one processor is further configured to:
transmit the signed transmission after a time period from transmitting the unsigned transmission.

8. The apparatus of claim 1, further comprising a transceiver coupled to the at least one processor, wherein, to transmit the signed transmission, the at least one processor is further configured to:
transmit, using the transceiver, the signed transmission after a plurality of unsigned transmissions have been transmitted to the backscattering-based communications device, wherein the plurality of unsigned transmissions comprises the unsigned transmission.

9. The apparatus of claim 1, wherein the at least one processor is further configured to:
receive a request for the signed transmission from the backscattering-based communications device, wherein, to transmit the signed transmission, the at least one processor is further configured to transmit the signed transmission in response to the request for the signed transmission.

10. An apparatus for wireless communication at a second wireless device, comprising:
a memory; and
at least one processor coupled to the memory and, based at least in part on information stored in the memory, the at least one processor is configured to:
receive a configuration of a backscattering-based communications device from a first wireless device;
receive a backscattered signal from the backscattering-based communications device; and
transmit a first detected error to the first wireless device in response to detecting an error in the backscattered signal based on the configuration of the backscattering-based communications device.

11. The apparatus of claim 10, wherein the at least one processor is further configured to:
receive a first public key from the first wireless device;
receive a signed transmission from the first wireless device; and
transmit a second detected error to the first wireless device in response to detecting an error in the signed transmission based on the first public key.

12. The apparatus of claim 10, further comprising a transceiver coupled to the at least one processor, wherein the at least one processor is further configured to:
receive, using the transceiver, a second public key from the backscattering-based communications device, wherein the backscattered signal comprises a signature; and
transmit, using the transceiver, a second detected error to the first wireless device in response to detecting an error in the signature based on the second public key.

13. The apparatus of claim 10, wherein, to detect the error in the backscattered signal, the at least one processor is further configured to detect the error in the backscattered signal based on at least one of (a) a time domain offset applied to the backscattered signal, (b) a frequency domain offset applied to the backscattered signal, (c) a codebook applied to the backscattered signal, (d) an angle of departure (AoD) offset applied to the backscattered signal, or (e) a position indicator associated with the backscattered signal.

14. An apparatus for wireless communication at a backscattering-based communications device, comprising:
a memory; and
at least one processor coupled to the memory and, based at least in part on information stored in the memory, the at least one processor is configured to:
receive a first public key from a first wireless device;
receive an unsigned transmission from the first wireless device;
receive a signed transmission from the first wireless device; and
process the unsigned transmission in response to verifying the signed transmission based on the first public key.

15. The apparatus of claim 14, wherein the at least one processor is further configured to:
transmit a verification of the signed transmission in response to verifying the signed transmission based on the first public key.

16. The apparatus of claim 15, wherein the at least one processor is further configured to:
receive a set of signed transmissions from the first wireless device, wherein, to transmit the verification of the signed transmission, the at least one processor is further configured to transmit a second verification of a plurality of signed transmissions including the signed transmission and the set of signed transmissions.

17. The apparatus of claim 14, wherein the at least one processor is further configured to:
decode the unsigned transmission using at least one of a second private key or a first symmetric key.

18. The apparatus of claim 14, further comprising a transceiver coupled to the at least one processor, wherein the at least one processor is further configured to:
transmit, using the transceiver, a radio frequency identification (RFID) capability, wherein the RFID capability comprises a time period between receiving a set of signed transmissions and transmitting a verification of the set of signed transmissions.

19. The apparatus of claim 14, wherein the at least one processor is further configured to:
transmit a request for the signed transmission to the first wireless device.

20. The apparatus of claim 14, wherein, to process the unsigned transmission, the at least one processor is further configured to:
transmit a response to a query of the unsigned transmission.

21. The apparatus of claim 20, wherein the at least one processor is further configured to:
transmit a second public key; and
sign the response to the query based on a second private key before transmitting the response to the query.

22. The apparatus of claim 14, wherein, to process the unsigned transmission, the at least one processor is further configured to:
backscatter a command of the unsigned transmission.

23. The apparatus of claim 22, wherein the at least one processor is further configured to:
transmit a second public key; and
sign the command based on a second private key before backscattering the command of the unsigned transmission.

24. The apparatus of claim 14, wherein, to verify the signed transmission, the at least one processor is further configured to:
verify the signed transmission based on at least one of (a) a time domain offset applied to the signed transmission, (b) a frequency domain offset applied to the signed transmission, or (c) a codebook applied to the signed transmission.

25. A method of wireless communication at a first wireless device, comprising:
transmitting a first public key to a backscattering-based communications device;
transmitting an unsigned transmission to the backscattering-based communications device; and
transmitting a signed transmission to the backscattering-based communications device, wherein the signed transmission is signed based on a first private key.

26. The method of claim 25, further comprising:
signing a portion of the unsigned transmission to generate the signed transmission.

27. The method of claim 26, further comprising:
multiplexing the signed transmission with the unsigned transmission to generate a payload for the backscattering-based communications device, wherein transmitting the unsigned transmission and transmitting the signed transmission comprises transmitting the payload to the backscattering-based communications device.

28. The method of claim 25, further comprising:
hashing a portion of the unsigned transmission; and
signing the hashed portion of the unsigned transmission to generate the signed transmission.

29. The method of claim 25, further comprising:
signing a signal that does not comprise a portion of the unsigned transmission to generate the signed transmission.

30. The method of claim 29, wherein transmitting the signed transmission comprises transmitting the signed transmission after a time period from transmitting the unsigned transmission.
